(19) United States
(12) Patent Application Publication
(10) Pub. No.: US 2009/0090875 A1
(43) Pub. Date: Apr. 9, 2009

(54) Higher pressure, modular target system for radioisotope production

(76) Inventors: William Z. Gelbart, Garden Bay (CA); Roberto A. Pavan, Vancouver (CA); Stefan K. Zeisler, Vancouver (CA)

Correspondence Address: HARNESS, DICKEY & PIERCE, P.L.C., P.O. BOX 8910, RESTON, VA, 20195, US

(21) Appl. No.: 12/213,614

(22) Filed: Jun. 23, 2008

Related U.S. Application Data
(60) Provisional application No. 60/945,586, filed on Jun. 22, 2007.

(51) Int. Cl. G21G 1/00; H01J 35/18; H01J 35/12

(52) U.S. Cl. 250/492.1; 378/161; 378/141

(57) ABSTRACT

A beam window according to example embodiments may include a foil having an interior region and an exterior region. The interior region of the foil may be dome-shaped, and a central portion of the dome-shaped interior region may be thinner than the exterior region of the foil. The beam window may be welded to a flange to form a window module. One or more window modules may be utilized in a target assembly. The target assembly may further include a cooling unit and/or collimator to form a target system according to example embodiments.

### PRIORITY STATEMENT

This application claims the benefit under 35 U.S.C. § 119(e) to U.S. Provisional Application No. 60/945,586, filed on Jun. 22, 2007 in the United States Patent and Trademark Office (USPTO), the entire contents of which are incorporated herein by reference.

### BACKGROUND

1. Technical Field

Example embodiments according to the present application relate to a method and system for radioisotope production.

2. Description of the Related Art

Radioisotopes are conventionally produced by the irradiation of a source material (e.g., source gas) in a target assembly, wherein the target assembly is designed as a dedicated and self-contained unit. This irradiation production method requires the vessel containing the gas to be separated from the accelerator vacuum by a thin barrier (usually known as a “window” or “beam window”). The beam window is relatively transparent to the irradiating beam.

Thin metallic foils are widely used as beam windows. Although relatively transparent to an irradiating beam (particularly at higher beam currents), a beam window will nevertheless still absorb some of the beam energy and can sustain heat damage if not properly cooled. Various configurations and materials have been used for the fabrication of beam windows, with each variation tending to have a corresponding influence on window performance.

### SUMMARY

A beam window according to example embodiments may include a foil having an interior region and an exterior region. The interior region of the foil may be dome-shaped, and a central portion of the dome-shaped interior region may be thinner than the exterior region of the foil. The foil may be formed of niobium, tungsten, a nickel-based alloy, a cobalt-based alloy, or an iron-based alloy. The beam window may be electroplated with a layer of silver, copper, and/or gold. A ratio of a thickness of the central portion of the dome-shaped interior region to a thickness of the exterior region of the foil may be about 1:2. For example, the thickness of the central portion of the dome-shaped interior region may be about 13 μm, and the thickness of the exterior region of the foil may be about 25 μm. The beam window may be welded to a flange to form a window module according to example embodiments. For example, the beam window may be electron beam welded to a Conflat (CF) flange.

A target system according to example embodiments may include a target assembly having a beam stop, a target chamber, and at least one window module. The target chamber may have a length of about 120-250 mm. The target assembly may include a plurality of window modules. For example, two window modules may be incorporated in the target assembly so as to define a coolant channel there between. A pressure in the coolant channel may be less than a pressure in the target chamber. The target system may also include a cooling unit configured to supply a liquid coolant to the coolant channel. The coolant may be liquid helium. The target system may further include a collimator for shaping an irradiating beam.

A method of forming a beam window according to example embodiments may include positioning a sheet material adjacent to a die having a dome-shaped cavity. The sheet material may be pressed into the dome-shaped cavity with a hydraulic fluid to form the beam window. The beam window may have an interior region and an exterior region. The interior region of the beam window may be dome-shaped, and a central portion of the dome-shaped interior region may be thinner than the exterior region of the beam window. The hydraulic fluid may be directed at the sheet material at about 4000 bar to press the sheet material into the dome-shaped cavity. The sheet material may be heat treated after being pressed.

A method of producing radioisotopes may include pressurizing a source gas within a target chamber and irradiating the source gas through at least one beam window. The beam window may have an interior region and an exterior region. The interior region of the beam window may be dome-shaped, and a central portion of the dome-shaped interior region may be thinner than the exterior region of the beam window. The source gas may have a pressure of about 13-23 bar before irradiation and a pressure of about 40-70 bar during irradiation. The source gas may be irradiated at a beam current of about 350-500 μA. During irradiation, the beam window may be cooled with liquid helium.

### BRIEF DESCRIPTION OF THE DRAWINGS

FIG. 1 is a cross-sectional view of the window modules of a target assembly according to example embodiments.

FIG. 2 is a diagram of a target system with a target assembly and cooling unit according to example embodiments.

FIG. 3 is a cross-sectional view of a method for forming a beam window according to example embodiments.

FIG. 4 is a cross-sectional view of a beam window according to example embodiments.

FIG. 5 is a cross-sectional view of a target assembly according to example embodiments.

FIG. 6 is a perspective view of a target assembly with spare window modules according to example embodiments.

FIG. 7A is a perspective view of a target system with a target assembly and collimation box according to example embodiments.

FIG. 7B is a cross-sectional view of a target system with a target assembly and collimation box according to example embodiments.

### DETAILED DESCRIPTION OF EXAMPLE EMBODIMENTS

It will be understood that when an element or layer is referred to as being “on”, “connected to”, “coupled to”, or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

A target assembly according to example embodiments may be designed to utilize a plurality of individual and reconfigurable window modules. As a result, a higher degree of application flexibility and serviceability may be achieved compared to the dedicated and self-contained units as conventionally used in the art. For example, the window modules according to example embodiments may be joined with relative ease to construct a multi-compartment target assembly having graduated pressure regions. Accordingly, higher pressure gas may be used in the target chamber while maintaining thinner (and, consequently, more transparent) beam windows.

It may be beneficial for a beam window to be relatively thin in addition to possessing sufficient mechanical strength (especially at elevated temperatures), adequate beam transparency, adequate heat conductivity, and a relatively low density and atomic mass. Furthermore, chemical compatibility, corrosion resistance, and other considerations may also be taken into account.

During radioisotope production, accelerators may deliver a particle beam having a roughly circular cross-section and a diameter of about 1-2 centimeters. After passing through the beam window, a portion of the beam may be stopped by a source material (e.g., source gas) contained within the target chamber. Production yields may be improved by increasing the likelihood of interaction between the source material and the beam. For example, when the source material is a gas, production yields may be improved by increasing the gas pressure and/or increasing the length of the target chamber. Thus, increasing the gas pressure may allow the use of a shorter target chamber. A shorter target chamber may be advantageous, at least in terms of space and activation.

On the other hand, because a beam diverges relatively quickly in a gas, the distal end of a longer target chamber may need to be designed to correspond to the shape of the enlarged beam. For example, a beam traveling through a source gas may diverge relatively quickly from an initial cylindrical shape to a conical shape. To compensate for the beam divergence, a longer target chamber may be designed to assume a corresponding shape. However, such a corresponding shape may create a considerable increase in the volume of the longer target chamber. As a result, the increased volume may render the use of certain source gases (e.g., expensive source gases) undesirable or even prohibitive.

In contrast, irradiating a source gas which is kept at a higher pressure in a target chamber may increase the likelihood that a majority of the beam will be absorbed within a shorter distance. Because of the shorter distance, the beam divergence may be relatively small. As a result, a shorter target chamber with a lower volume may be utilized. Consequently, the lower volume may allow the use of a broader range of source gases.

A metal foil may be used to form a beam window. The metal foil should have sufficient mechanical strength to maintain the elevated pressures within the target chamber. The metal foil should also be able to maintain its strength at elevated temperatures as well as after repeated thermal cycling. The metal foil may be formed of various suitable metals, including niobium (Nb) and/or tungsten (W). The metal foil may also be formed of a suitable alloy, including Inconel, Monel, Havar, Biodur 108, and Super-Invar, although example embodiments are not limited to the above elements and materials. The metal foil may have a thickness of about 10 to 50 microns.

Although the source gas may provide some convective cooling during irradiation, operations involving higher beam currents may require the use of active cooling (e.g., forced gas and/or liquid cooling) to maintain the temperatures of the beam window and/or the target chamber surfaces within desirable ranges.

Active cooling may be achieved by creating a channel in the target assembly for circulating a coolant (e.g., liquid, gas). The coolant channel may be adjacent to the beam window while also being isolated from the accelerator vacuum and the target chamber. For example, two or more beam windows may be used to create the coolant channel, and a coolant may be circulated through the channel to cool the beam windows. The coolant may be a fluid with a relatively high thermal conductivity (e.g., helium (He)). Additionally, the pressure inside the coolant channel may be less than (e.g., half) the pressure inside the target chamber, thereby reducing the pressure differential to which each of the adjacent beam windows will be exposed. This concept is not limited to a configuration with a single coolant channel. Rather, the concept may be extended to configurations having a plurality of coolant channels with corresponding pressure drops.

Where beam windows are used to define the coolant channels, the number of coolant channels N_{c} may be one less than the number of beam windows N_{f} (e.g., N_{c}=N_{f}−1). Consequently, where a plurality of beam windows are utilized, the pressure differential between the target chamber pressure Pₜ and the accelerator vacuum pressure Pₐ may be divided among the number of beam windows N_{f}, (e.g., (Pₜ−Pₐ)/N_{f}).

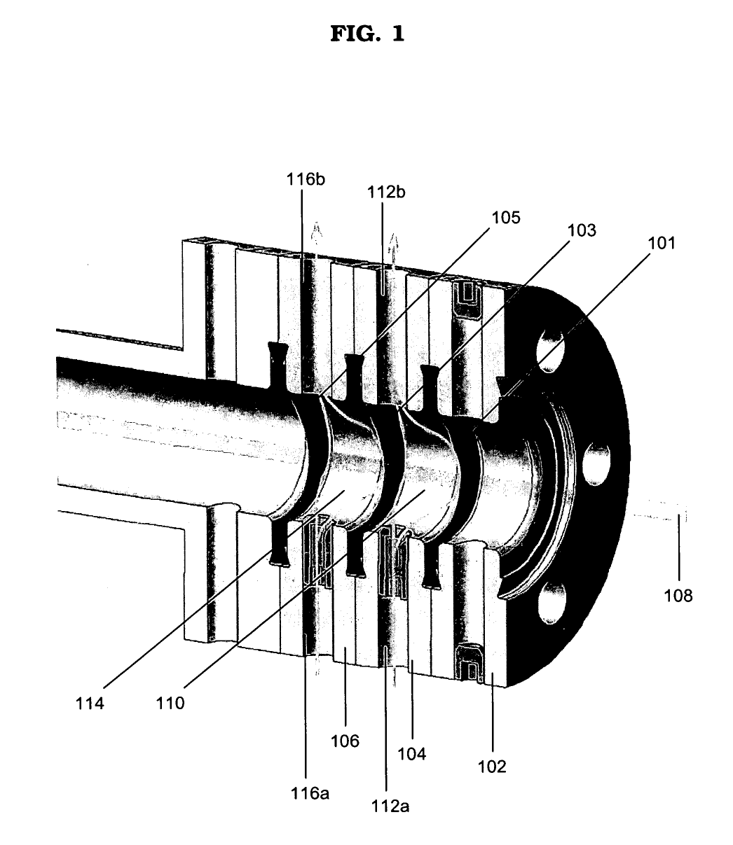

FIG. 1 is a cross-sectional view of the window modules of a target assembly according to example embodiments. Referring to FIG. 1, the target assembly may have a first beam window 101, second beam window 103, and third beam window 105 arranged in the path of an irradiating beam 108. The first beam window 101 may be welded to a first flange 102 to form a first window module. Similarly, the second beam window 103 may be welded to a second flange 104 to form a second window module, and the third beam window 105 may be welded to a third flange 106 to form a third window module. The first beam window 101 and second beam window 103 may define a first coolant channel 110. The first coolant channel 110 may have a first inlet 112a and a first outlet 112b for circulating a coolant. Similarly, the second beam window 103 and the third beam window 105 may define a second coolant channel 114. The second coolant channel 114 may have a second inlet 116a and a second outlet 116b for circulating a coolant.

To increase cooling efficiency, the entering coolant may be aimed directly at one or more of the beam windows using guides of proper geometry inserted in the inlet. The exiting coolant may be cooled before being resupplied to the channel. For example, the exiting coolant may be cooled with a cooling system using liquid-cooled heat exchangers and/or cryogenic compressors. If a cryogenic compressor is utilized, pressure balancing on the intake and output of the compressor may be required to maintain the pressures within the compressor's operating range and to create the pressure differences in the coolant channel.

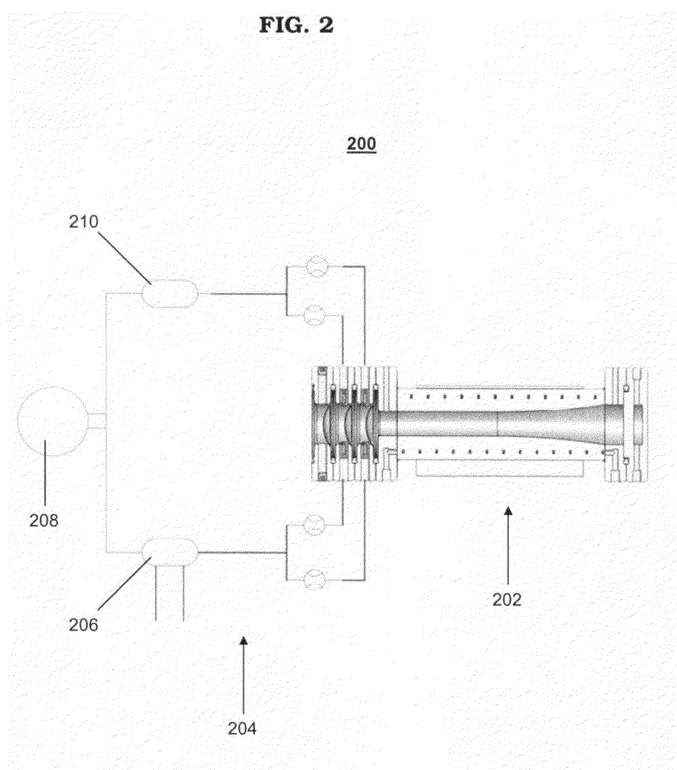

FIG. 2 is a diagram of a target system with a target assembly and cooling unit according to example embodiments. Referring to FIG. 2, a target system 200 may include a target assembly 202 that is cooled by a cooling unit 204. During operation, the cooling unit 204 may supply coolant to the target assembly 202. The coolant exiting the channels of the target assembly 202 may be sequentially transported to a heat exchanger 206, compressor 208, and receiver 210 before being resupplied to the channels.

Conventional target assemblies use flat beam windows, partly for simplicity and partly for historical reasons. A conventional beam window may be a flat foil clamped between two seals, although welding is used in some instances. While a conventional flat beam window may be relatively simple to produce, the flat geometry lacks the strength of a dome-shaped beam window according to example embodiments. Thus, a pressure that would destroy the conventional flat beam window may only cause an acceptable level of stress on the domed-shaped beam window according to example embodiments.

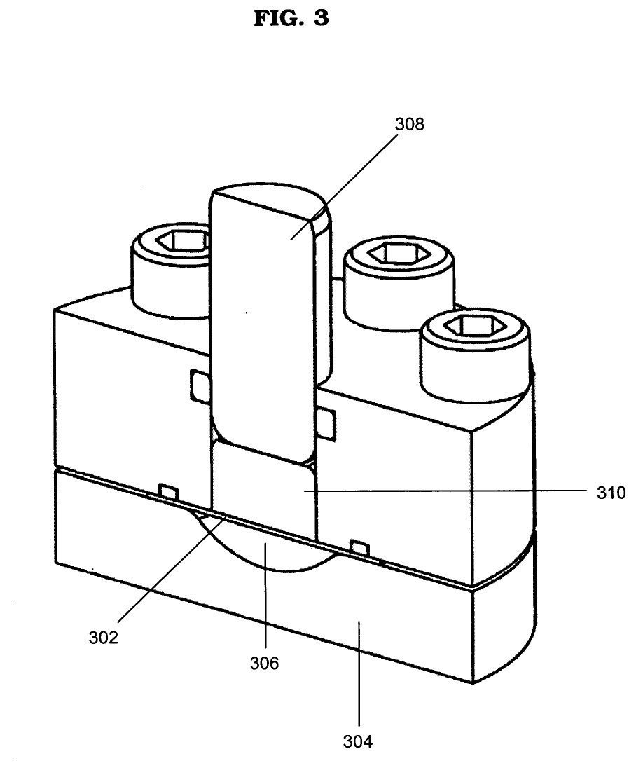

A hydraulic forming method (e.g., hydroforming) may be used to produce the dome-shaped beam window. FIG. 3 is a cross-sectional view of a method for forming a beam window according to example embodiments. Referring to FIG. 3, a sheet of an annealed window material 302 may be positioned adjacent to a die 304. The die 304 may have a dome-shaped cavity 306. A piston 308 may drive a hydraulic fluid 310 so as to press the sheet of the annealed window material 302 into the dome-shaped cavity 306 so as to achieve a dome-shaped beam window. The beam window may reach its full temper from work hardening.

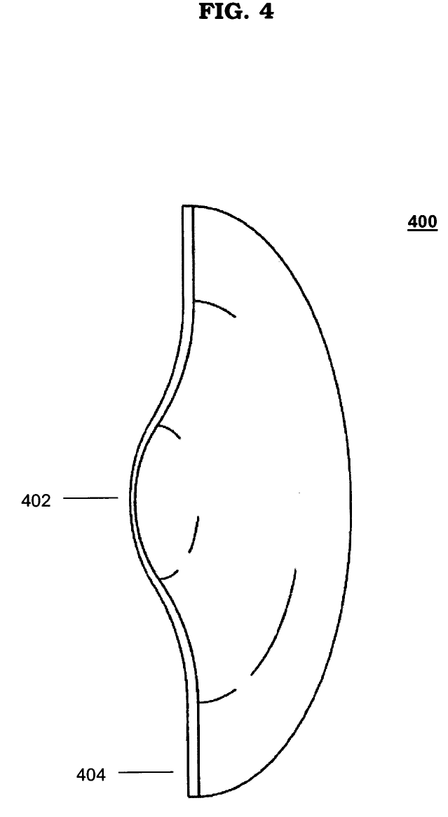

FIG. 4 is a cross-sectional view of a beam window according to example embodiments. Referring to FIG. 4, the center 402 of the dome-shaped beam window 400 may be relatively thin compared to the edge 404. The thinner center 402 may increase the transparency of the beam window 400. Consequently, the amount of energy lost by an irradiating beam traveling through the beam window 400 may be reduced. The beam window according to example embodiments may have a smaller diameter than a conventional window.

The beam window may be electroplated with a metal (e.g., silver (Ag), copper (Cu)) to improve heat conduction. For example, a layer of silver having a thickness of about 4 to 8 micrometers may improve window cooling while having a relatively small effect on the irradiating beam. As will be appreciated, thicker layers may further improve window cooling while having an increasing effect on the irradiating beam. During the electroplating process, a relatively thin nickel (Ni) transition strike may be used to achieve improved adhesion between the base material and the plating material. The plated beam window may be electron beam welded to a Conflat (CF) flange to produce a window module.

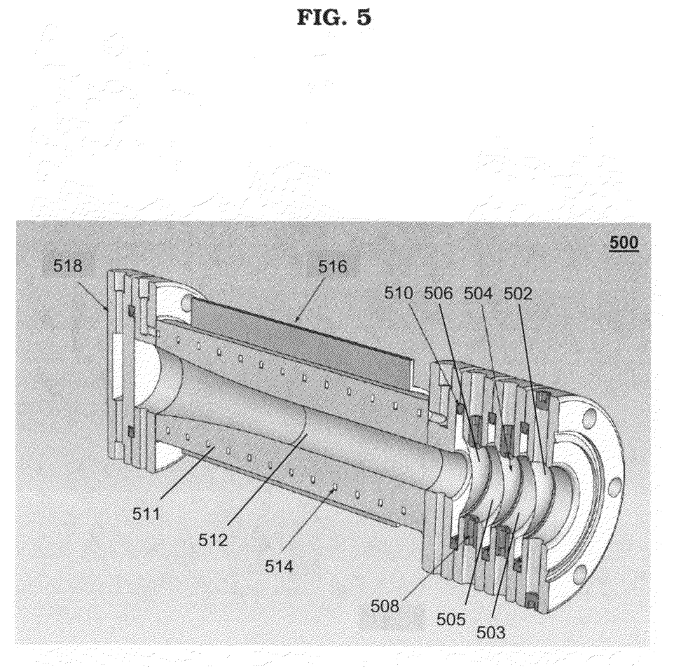

FIG. 5 is a cross-sectional view of a target assembly according to example embodiments. Referring to FIG. 5, the proximal end of the target assembly 500 may include a first beam window 502, a second beam window 504, and a third beam window 506. The first beam window 502 may have been welded to a first flange as part of a first window module. Similarly, the second beam window 504 may have been welded to a second flange as part of a second window module, and the third beam window 506 may have been welded to a third flange as part of a third window module. A seal 510 (e.g., copper seal) may be disposed between the window modules.

The first beam window 502 and the second beam window 504 may define a first coolant channel 503. Similarly, the second beam window 504 and the third beam window 506 may define a second coolant channel 505. A guide 508 (e.g., helium jet) may be arranged in an inlet of the first coolant channel 503 and/or the second coolant channel 505 to aim the coolant directly at the first beam window 502, second beam window 504, and/or third beam window 506. The target body 511 of the target assembly 500 may define a target chamber 512. The center of the first, second, and third beam windows 502, 504, and 506, respectively, may be aligned with the longitudinal axis of the target chamber 512. The target chamber 512 may be surrounded by internal coolant paths 514 within the target body 511. Additionally, the target body 511 may be surrounded by a heater 516. A beam stop 518 may be adjoined to the distal end of the target body 511.

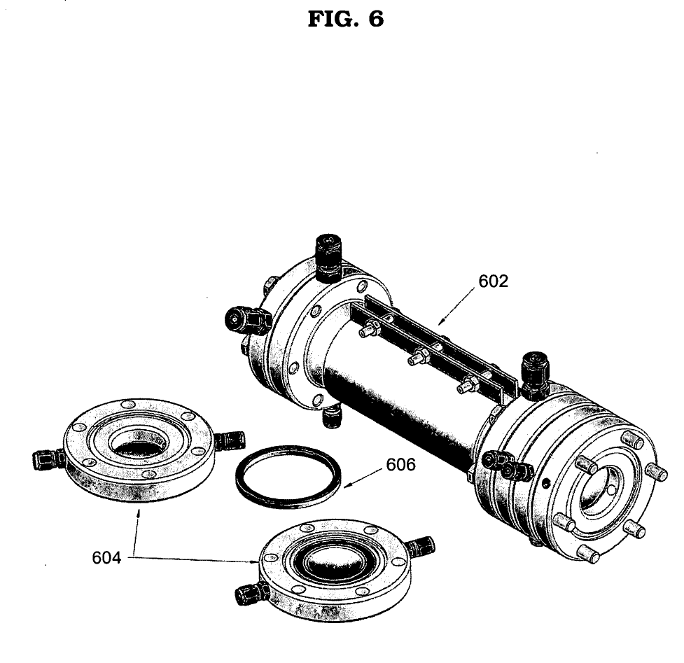

FIG. 6 is a perspective view of a target assembly with spare window modules according to example embodiments. Referring to FIG. 6, the target assembly 602 may have three window modules secured to the proximal end thereof. The spare window modules 604 may serve as replacement modules. Alternatively, the target assembly 602 may be modified with relative ease to include the window modules 604. A seal 606 may be disposed between the window modules.

The target body may be a tubular section of appropriate length with a flange at each end. The flange may be machined or welded to each end. The material for forming the target body may depend on the source gas, the process employed, and other factors considered by those ordinarily skilled in the art. For example, from an activation point of view, substantially pure aluminum (Al) may be a suitable material. The surfaces of the target chamber contacting the source gas may be electroplated with a suitable material (e.g., an adsorptive material) so as to be more compatible with the product being collected and/or the particular process being utilized.

The diameter of the target chamber may increase along its length. For example, the proximal end of the target chamber may have a diameter of about 15 mm, while the distal end of the target chamber may have a diameter of about 25 mm. Additionally, the length of the target chamber may be about 120 mm, and the volume may be about 30 cm³. At higher operating pressures, the length of the target chamber may be reduced while still attaining similar levels of productivity. The rate of heat removal may define the extent to which the length of the target chamber may be reduced. It should be appreciated that example embodiments are not limited to the above dimensions. For instance, the length of the target chamber may be more than the above-discussed quantity (e.g., 250 mm).

The target assembly according to example embodiments may be operated at various energy levels. For instance, when the target assembly is operated at about 30 MeV, about 10 MeV (of the 30 MeV) may be absorbed by the source gas while the remaining approximately 20 MeV may pass through the source gas and be absorbed by the beam stop. The target assembly may also be operated in a constant volume mode with an initial pressure of about 13 bar at room temperature. During operation, the pressure may stabilize at about 40 bar. However, it will be appreciated that the target assembly may be operated at pressure ratios higher than about 13 bar: 40 bar (e.g., about 20 bar: 60 bar).

The target assembly may use a beam current of about 500 μA or more. Although no problems with the beam window performance are anticipated at higher beam currents, the limiting factor may be the ability to maintain sufficient cooling of the target body and/or beam stop. When adequate cooling is attained, a yield of 35 mCi/μAhr or more may be achieved.

The target chamber may be designed to conform to the shape of the irradiating beam. For example, the shape of the target chamber may be conical, trumpet-like, or stepped. As discussed above, the volume of the target chamber may be kept to an acceptable degree by utilizing a shorter target chamber that is operated at a higher pressure. The unused portion of the irradiating beam may be absorbed by the beam stop. The beam stop may be fabricated from relatively high purity aluminum that is of sufficient thickness to stop the beam. The beam stop may utilize a radial or axial flow of coolant (e.g., liquid water) to achieve sufficient cooling. The interior surface of the beam stop that is exposed to the source gas may be prepared and/or treated in the same way as the surface of the target chamber.

Furthermore, the excess portion of the irradiating beam may be used to produce additional, different radioisotopes by constructing a “piggyback” target at the beam stop. The modular design of the target assembly makes this variation easier to implement.

With some modifications, the above-described method according to example embodiments was used to form a series of dome-shaped beam windows. The beam windows were formed of fully-annealed, 25 μm thick Havar under a pressure of approximately 4000 bar. The extent of deformation was adjusted using a series of different dies to achieve both improved deflection and an increased degree of temper of the metal. The resulting windows were relatively strong, while exhibiting about a 50% thickness reduction at the center. Hydrostatic burst tests showed a consistent burst pressure of 125±5 bar (at room temperature), which is relatively remarkable for a beam window that is only about 13 μm thick at the center. This initial post-deformation strength may be further increased by about 25% by utilizing an appropriate post-deformation heat treatment. The temperature of the beam window during full beam irradiation is not expected to exceed 500° C. In any event, at 500° C., Havar may still maintain about 75% of its original strength. Given the performance of the sample beam windows discussed above, this would translate into a burst pressure of about 94 bar and a safety factor of at least about 5 when utilizing a triple beam window arrangement.

During irradiation, the beam may need to be focused and collimated to fit the target aperture. To ensure proper distribution, the beam may be truncated to a circular shape that still maintains about 85% of its original (pre-truncated) power. This truncation may reduce or prevent the occurrence of a disproportionately hot spot in the beam center, thus improving the usage of the source material and protecting the beam windows from heat damage. For lower beam currents, placing a relatively simple circular collimator in front of the beam window may be adequate. On the other hand, for higher beam currents, more robust collimators may be needed as well as a better way to determine the beam position.

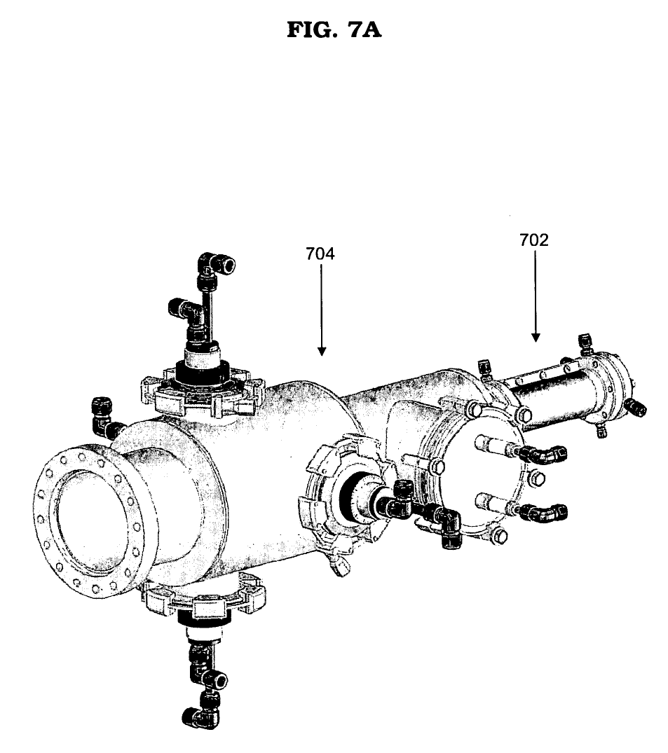

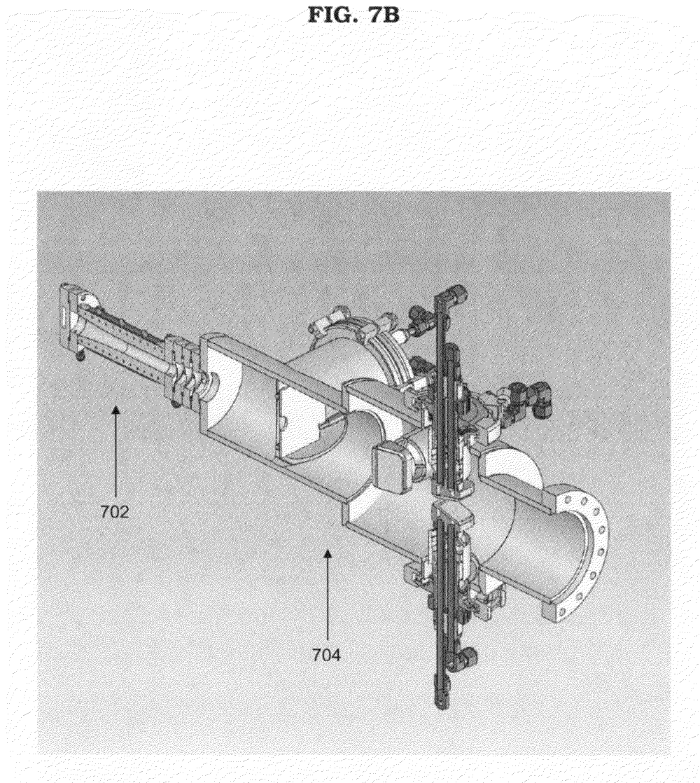

FIG. 7A is a perspective view of a target system with a target assembly and collimation box according to example embodiments. FIG. 7B is a cross-sectional view of a target system with a target assembly and collimation box according to example embodiments. Referring to FIGS. 7A-7B, a collimation box 704 may be adjoined to the proximal end of the target assembly 702.

For instance, four independent, high current collimators may be placed in front of a target assembly according to example embodiments. The collimators may be used to shape the beam to approximately a 14 mm square shape. The final shaping may be performed by a circular mask. The circular mask may be about 14 mm in diameter and placed relatively close to the beam window. The collimators and the mask may be fabricated from relatively high purity aluminum to reduce activation during the subsequent irradiation of the source material.

The target assembly according to example embodiments may increase (e.g., 2×-3×) production yields compared to a conventional gas target assembly. Additionally, the target assembly according to example embodiments may provide simpler maintenance because of the modular design, increased life expectancy of the windows, and easier operation.

While example embodiments have been disclosed herein, it should be understood that other variations may be possible. Such variations are not to be regarded as a departure from the spirit and scope of example embodiments of the present application, and all such modifications as would be obvious to one skilled in the art are intended to be included within the scope of the following claims.

1. A beam window comprising:
a foil having an interior region and an exterior region, the interior region of the foil being dome-shaped, and a central portion of the dome-shaped interior region being thinner than the exterior region of the foil.

2. The beam window of claim 1, wherein the foil is formed of niobium, tungsten, a nickel-based alloy, a cobalt-based alloy, or an iron-based alloy.

3. The beam window of claim 1, further comprising:
an electroplated layer of silver or copper.

4. The beam window of claim 1, wherein a ratio of a thickness of the central portion of the dome-shaped interior region to a thickness of the exterior region of the foil is about 1:2.

5. The beam window of claim 4, wherein the thickness of the central portion of the dome-shaped interior region is about 13 μm, and the thickness of the exterior region of the foil is about 25 μm.

6. A window module, comprising:
a flange; and
the beam window according to claim 1, the beam window being welded to the flange.

7. A target system comprising:
a target assembly including a beam stop, a target chamber, and at least one window module according to claim 6.

8. The target system of claim 7, wherein the target chamber has a length of about 120-250 mm.

9. The target system of claim 7, wherein the at least one window module includes two window modules, the two window modules defining a coolant channel there between.

10. The target system of claim 9, wherein a pressure in the coolant channel is less than a pressure in the target chamber.

11. The target system of claim 9, further comprising:
a cooling unit configured to supply a liquid coolant to the coolant channel.

12. The target system of claim 11, wherein the coolant is liquid helium.

13. The target system of claim 7, further comprising:
a collimator for shaping an irradiating beam.

14. A method of forming a beam window, comprising:
positioning a sheet material adjacent to a die having a dome-shaped cavity; and
pressing the sheet material into the dome-shaped cavity with a hydraulic fluid to form the beam window, the beam window having an interior region and an exterior region, the interior region of the beam window being dome-shaped, and a central portion of the dome-shaped interior region being thinner than the exterior region of the beam window.

15. The method of claim 14, wherein the hydraulic fluid is directed at the sheet material at about 4000 bar to press the sheet material into the dome-shaped cavity.

16. The method of claim 14, wherein the sheet material is heat treated after being pressed.

17. A method of producing radioisotopes, comprising:
pressurizing a source gas within a target chamber; and
irradiating the source gas through at least one beam window, the beam window having an interior region and an exterior region, the interior region of the beam window being dome-shaped, and a central portion of the dome-shaped interior region being thinner than the exterior region of the beam window.

18. The method of claim 17, wherein the source gas has a pressure of about 13-23 bar before irradiation and a pressure of about 40-70 bar during irradiation.

19. The method of claim 17, wherein the source gas is irradiated at a beam current of about 350-500 μA.

20. The method of claim 17, further comprising:
cooling the beam window with liquid helium.
